(19) United States
(12) Patent Application Publication
(10) Pub. No.: US 2019/0166103 A1
(43) Pub. Date: May 30, 2019

(54) METHOD FOR PERMITTING MULTIPLE REMOTE ACCESSES TO DIGITAL ENVIRONMENT BASED ON HUMAN BEHAVIOR EXPERIENCE

(71) Applicant: SAMSUNG ELETRONICA DA AMAZONIA LTDA., CAMPINAS (BR)

(72) Inventors: Rodrigo José TOBIAS, CAMPINAS (BR); Renata Zilse BORGES, CAMPINAS (BR)

(73) Assignee: SAMSUNG ELETRONICA DA AMAZONIA LTDA., CAMPINAS (BR)

(21) Appl. No.: 15/961,450

(22) Filed: Apr. 24, 2018

(30) Foreign Application Priority Data
Nov. 30, 2017 (BR) 10 2017 025882 3

(51) Int. Cl. H04L 29/06

(52) U.S. Cl. CPC H04L 63/0428; H04L 63/0876

(57) ABSTRACT

A method to allow multiple remote accesses to digital environment based on human behavior experience related to wearable technologies and IoT devices, the method including: inputting vault control parameters under the smart watch device such as elected numbers, direction of movement, and the resting-time over each chosen number, completing the “total vault command”; cryptographing/encrypting the “vault command” performed in the inputting; authenticating “elected numbers”, direction of movement, and the resting-time over each chosen number; and, validating “elected numbers”, direction of movement, and the resting-time over each chosen number, completing the “total vault command”.

### CROSS-REFERENCE TO RELATED APPLICATIONS

This application claims the foreign priority benefit of Brazilian Patent Application No. 10 2017 025882 3, filed on Nov. 30, 2017 in the Brazilian Intellectual Property Office, the disclosure of which is incorporated herein by reference.

### BACKGROUND

### 1. Field

The following description refers to usability and new application for wearable technologies and IoT devices, based on human behavior experience in taking interface with a secure technology. More specifically it describes a new method and useful interface of authentication and encryption objects (IoT) and payment transactions, preferentially for smartwatch with rotate bezel. A method that adds extra security and simplicity in a unique interface similar as a locker or a vault, that increases a human behavior sense to the activities of making/bringing security at the daily actions.

### 2. Description of Related Art

There is no authentication and encryption solution in the market for Smart Watch, effective and simple for the user.

Currently, physical aspects of the clock (bezel) and action adding are not being used to ensure extra security for the method. Use the same logic of the lock, in a brand-new way. Adding action at smartwatch (for example, Gear S3) to clockwise and counterclockwise direction in the password for validation/authentication process.

The Patent US 2014/0298432 A1 titled “METHOD AND APPARATUS FOR AUTOMATED PASSWORD ENTRY”, by Wendell D. Brown, filed on Oct. 2, 2014, proposes a method and apparatus for protecting security credentials (e.g., username/password combinations) and/or other sensitive data in a “password vault”. A password vault device may be incorporated into a portable (or even wearable) electronic device, such as a smart phone, smart watch, smart glasses, etc. When a security credential is requested during a user's operation of the password vault device or some other computing/communication device, such as when the user is accessing an online site or service via a browser program, the request is passed to the password vault, and the appropriate security credential is retrieved, delivered, and entered into the requesting interface. The difference between the disclosure of present invention and document US 2014/0298432 is in the amplitude of use spectrum. The disclosure of the present invention allows a very high possibility of use, in case of remote access, not restrictive to passwords or login/logout.

Another described prior-art is proposed by the inventor Vincent Ramoutar, that proposes a tiny, smartphone and tablet compatible multifunction wireless device you attach to a keychain and protects the user's mobile identity. Using a Near Field Communication (NFC) connection, it pairs seamlessly with the mobile lynk apps on smartphones and tablets (http://uconekt.com/secure-your-digital-data-with-lynk/). It contains four-layer authentication and 128 bit AES encryption technology that stores your passwords, PINs, credit card numbers and provides easy access to all the bank and trading accounts and allows on-line shopping and making mobile payments securely on the go. With lynk's proximity range indicator, it can also keep tabs on user's smartphone and alert the user when it's out of range allowing the user to tailor those settings that may differ when he is at work, home or on the road. The user can set the alert to be a buzzer, vibration or even a ringtone, and if he needs to find his phone, may be it is stuck/lost in the couch or in your coat pocket; the user simply taps its lynk three times and his alert will be enabled even if the user's phone is set to silent mode. The lynk is powered by a CR2032 coin cell battery that should last about three to four months before it needs to be changed. The app can also remind the user how much battery life the user actually has left. The concept of this device is different because in this solution the user must carry an extra device, and the present disclosure concentrates all access at the smart watch with rotate bezel (e.g. Samsung Gear S3).

The U.S. Pat. No. 6,556,222 B1 titled “BEZEL BASED INPUT MECHANISM AND USER INTERFACE FOR A SMART WATCH”, by INTERNATIONAL BUSINESS MACHINES CORPORATION, filed on Jun. 30, 2000, refers to a wearable mobile computing device/appliance (e.g., a wrist watch) with a display that is capable of wirelessly accessing information from the network and a variety of other devices. The mobile computing device/appliance includes a user interface employing a bezel-based input mechanism including a bezel ring which may be rotated and depressed for generating both rotation and wheel click events for enabling navigation, selection and entry of various displayed textual and graphical items. However, document U.S. Pat. No. 6,556,222 B1 addresses more specifically a solution (from 17 years ago) to select items from a menu with a rotating bezel. Regarding the present invention, main difference is to use the rotating bezel like a “safe”/“vault”. Currently, there is no vault solutions for smart watch. Moreover, currently there is no physical method (clockwise and counterclockwise rotating movements, plus numbers) that adds extra layer/protection for password authentication in wearable devices.

### SUMMARY OF THE INVENTION

The present patent of invention is related to usability and new application for wearable technologies and IoT devices, based on human behavior experience in taking interface with a secure technology. More specifically, it is described a new method and useful interface of authentication and encryption objects (IoT) and payment transactions, preferentially for smartwatch with rotating bezel (e.g. Samsung Gear S3). A method that adds extra security and simplicity in a unique interface similar as a locker or a vault, that increases security sense in the human behavior to the activities at the daily actions. This invention proposes an analogy to use the smart watch like a safe vault. Using gloves and/or with wet hands without comprising its operation; so, these two examples are perfect for using the Vault, as proposed in our patent. This method can be complementary to a more precise identification and validation. Ex. Use of iris+pin code+vault.

The present disclosure defines a method to allow multiple remote accesses to digital environment based on human behavior experience related to wearable technologies and IoT devices, comprises the steps of:

inputting vault control parameters under the smart watch device such as elected numbers, direction of movement, and the resting-time over each chosen number, completing the “total vault command”;

encrypting the “vault command” performed in the input step;

authenticating “elected numbers”, direction of movement (Clockwise or counterclockwise movement), and the resting-time over each chosen number;

validation of “elected numbers”, direction of movement (Clockwise or counterclockwise movement), and the resting-time over each chosen number, completing the “total vault command”.

A smartwatch having the method of the present disclosure provides a unique and revolutionary circular user interface, comprising a rotating bezel which can perform multiple actions and features. For example, users can turn/rotate the bezel to answer/reject an incoming call, turn up/down the volume, turn on/off the alarm, scroll through apps, messages, etc. The present disclosure advantageously proposes a new function/feature to the rotating bezel: it emulates a real vault/safe, wherein the user can input/rotate a “numeric secret” (password) to open the vault/safe (authentication).

In addition, the present disclosure provides an extra protection to sensitive/financial transactions. For example, it could be used as a new manner of authenticating payments platforms.

### BRIEF DESCRIPTION OF THE DRAWINGS

The objectives and advantages of the present disclosure will become clearer through the following detailed description of the example and non-limitative figures presented at the end of this document, wherein:

FIG. 1 discloses an example of a prior art document disclosing a method and apparatus provided for retaining and automatically entering a login password or security credential for external digital systems;

FIG. 2 discloses another exemplar use of a prior-art proposition, in terms of an authentication method U-Connect;

FIG. 3 discloses an example of the human behavior authentication in case of all IoT devices (consumer electronics) with extra protection and locked, where no changes can be made while the vault use proposed at the present disclosure is active.

FIG. 4 discloses another embodiment where Human Behavior Authentication in case of expensive payment transactions.

FIG. 5 represents the preferred embodiment of the present disclosure.

### DETAILED DESCRIPTION

FIG. 1 discloses an example of a prior art document disclosing a method and apparatus provided for retaining and automatically entering a login password or security credential on the computer 110 for external digital systems 100.

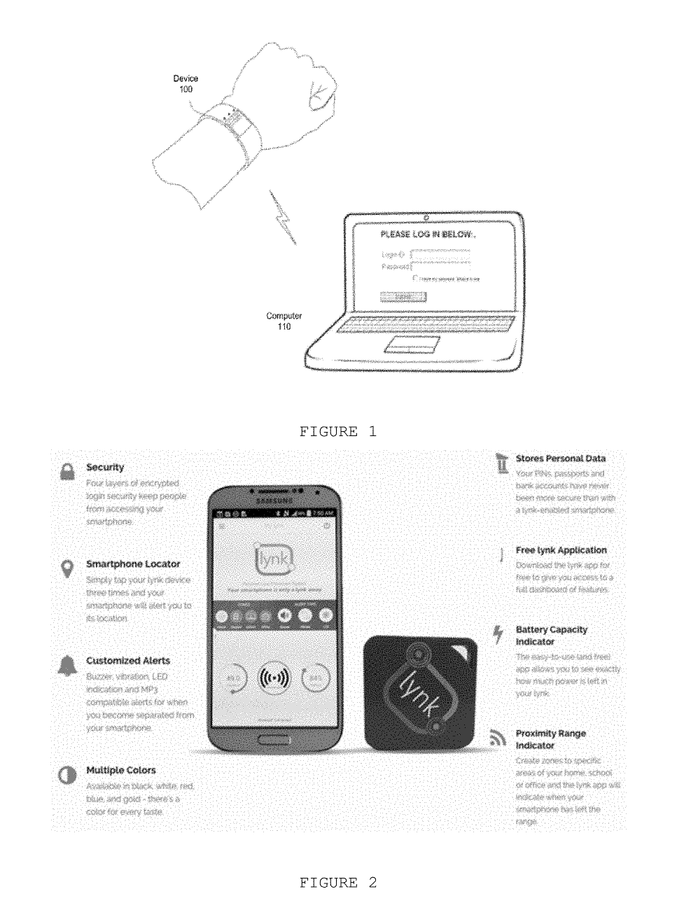

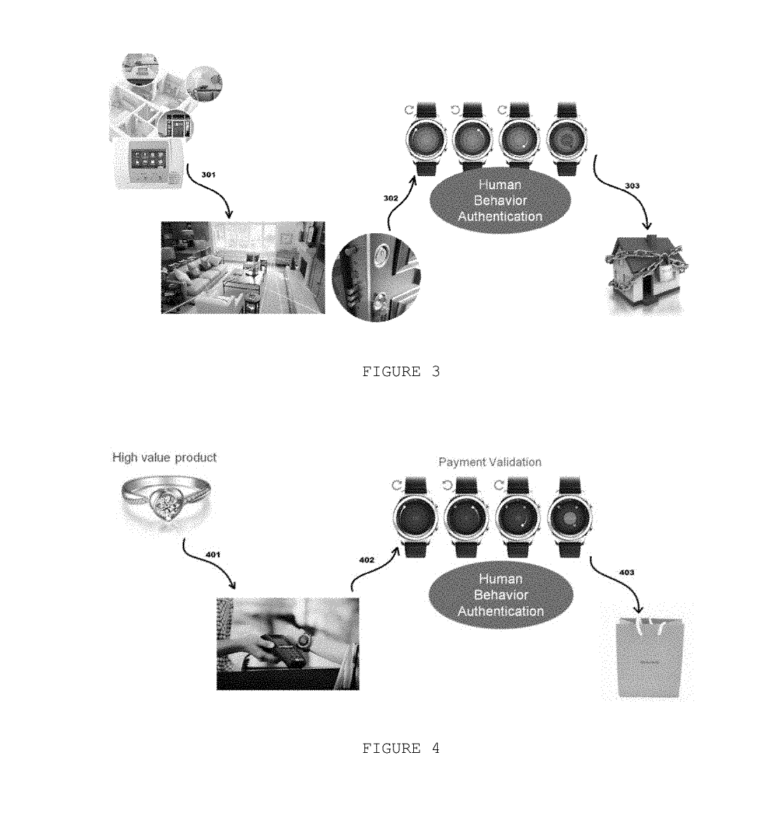

Described at FIG. 2, lynk is being launched through uConeckt, a Toronto based mobile-tech startup company lead by Ramoutar, the company's CEO and founder. The lynk is compatible to Android operating system, and the company is looking to crowd source funds to help complete testing and production for devices with other operating systems, such as iPhone, BlackBerry and Windows.

The present disclosure is related to usability and new application for wearable technologies and IoT devices, based on human behavior experience in taking interface with a secure technology. More specifically it describes a new method and useful interface of authentication and encryption objects (IoT) and payment transactions, preferentially for smart watch devices. A method that adds extra security and simplicity in a unique interface similar as a locker or a vault, that increases a security sense in the human behavior to the activities at the daily actions.

At the proposed use-case actions, the embodiments below are listed:

### Embodiment 1—Human Behavior Authentication in which all IoT Devices (Consumer Electronics) have Extra Protection and are Locked, where No Changes can be Made while the “Vault Use” is Active

At home, router of the user can configure and authenticate new devices for personally and safely. A simple way for the user's smart devices to pair and add an extra layer of protection.

FIG. 3 illustrates the proposition in which human behavior authentication in case of all IoT devices (consumer electronics) having extra protection and are locked, where no changes can be made while the vault use is active. At first step 301, the user can start individually (or not) all the alarm configurations related to each segment or apparatus in the user's house. After that, the user of the method proposed by the present disclosure can configure individually each alarm element using the NFC technique that activates the sensor of the smartwatch vault (302) or using any other “proximity technique” to turn on and turn off the locked system.

The role action of individual programming at the user's house can ensure the behavioral authentication at the act of locked the user's house. It doesn't matter if someone can entry at the house because the locker-system has an extra condition to turn off 303.

### Embodiment 2—Paying Expensive Transactions or not Usual Payments

At the act of a payment for an expensive transaction, the smart watch can be used as extra step for validation of the purchase, without mobile authentication or card. The FIG. 4 illustrates the proposition. At FIG. 4, the user can pay (401) the value using another feature of smartwatch device. Subsequently, the user can authenticate this purchase through purchase validation (402) using the method steps of the present disclosure of the electronic device. It provides an extra validation to proof for the user's bank account controller his decision to buy an expensive transaction 403.

### Preferred Embodiment—Smart Watch Used Like a Vault Apparatus

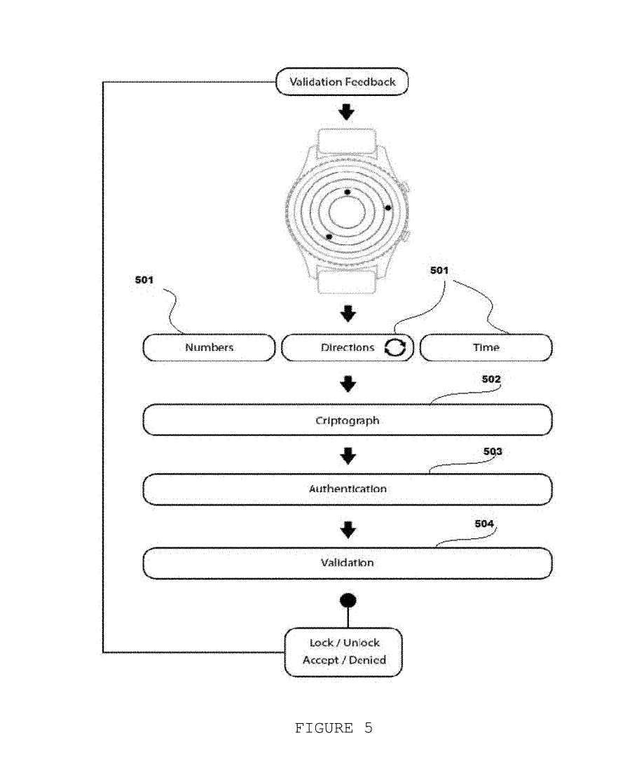

FIG. 5 represents the preferred embodiment of the invention, wherein the entering of vault control parameters 501 under the smart watch device is represented: “elected numbers”, direction of movement (Clockwise or counterclockwise movement), and the resting-time over each chosen number, completing the “total vault command”. The step 502 represents a cryptography technique used to keep high security over this “vault command” formed at the step 501. The steps 503 and 504 represent respectively the authentication and validation of the encrypted code transmitted by the smart watch device to the focused object to be locked/unlocked through this vault operation. The steps 502, 503 and 504 are not considered within the scope of the proposed disclosure.

### Complementary Objectives and General Embodiment

There are no solutions for smart watches similar to that of the proposed method; They use the mobile device for it. There is no physical method that adds extra protection in the user's password (clockwise and counterclockwise movements, plus numbers).

A method to allow multiple remote accesses to digital environment based on human behavior experience, as disclosed above comprises a complementary method to joint use and to give more precision identification and validation to other secure access like: use of iris or pin code or biometry.

According to a general embodiment, the preferred authentication method is a two-factor authentication (2FA) or a multi-factor authentication (MFA). An example of two-factor authentication (2FA) is the combination of something that user knows (such PIN number, password, etc.) and something that the user have (e.g. the smartwatch with rotate bezel, which allows clockwise and counterclockwise movements to enter the PIN/password). A good example of multi-factor authentication (MFA) is the combination of the above mentioned two-factors (PIN/password+smartwatch with rotate bezel, which allows clockwise and counterclockwise movements to enter the said PIN/password) further comprising some physical characteristics of the user (biometrics/inherence, e.g. fingerprint, iris recognition, face recognition, etc.).

Regarding the data transfer/exchange (transmission of code from smart watch to the target object to be locked/unlocked), it can be used existing wireless technologies and methods such as Wi-Fi Direct, Bluetooth, Bluetooth Low Energy (BLE), Near Field Communication (NFC), etc.

As for cryptographic methods, the solution of the present invention may use many existing and classic techniques and even those available according the wireless data transfer technology. For example: more recent versions of Bluetooth (i.e. Bluetooth 4.0, BLE) uses 128-bit Advanced Encryption Standard (AES).

Although the present disclosure has been described in connection with certain preferred embodiments, it should be understood that it is not intended to limit the disclosure to those particular embodiments. Rather, it is intended to cover all alternatives, modifications and equivalents possible within the spirit and scope of the disclosure as defined by the appended claims.

1. A method to allow multiple remote accesses to digital environment based on human behavior experience related to wearable technologies and IoT devices, comprising:
inputting vault control parameters under the smart watch device such as elected numbers, direction of movement, and the resting-time over each chosen number, completing the “total vault command”;
cryptographing/encrypting the “vault command” performed in the inputting vault control parameters;
authenticating “elected numbers”, direction of movement, and the resting-time over each chosen number;
validating “elected numbers”, direction of movement, and the resting-time over each chosen number, completing the “total vault command”.

2. A method to allow multiple remote accesses to digital environment based on human behavior experience, according to claim 1, wherein the inputting vault control parameters further comprises:
starting individually all the alarm configurations related to each segment or apparatus in a house; and
configuring individually each alarm element using the NFC technique that activates the sensor of the smartwatch vault.

3. A method to allow multiple remote accesses to digital environment based on human behavior experience, according to claim 1, wherein the direction of movement consists in Clockwise or counterclockwise movement.

4. A method to allow multiple remote accesses to digital environment based on human behavior experience, according to claim 1, comprising a Besel movement to select elected numbers and correct direction validation to choose a vault-code.

5. A method to allow multiple remote accesses to digital environment based on human behavior experience, according to claim 1, comprising a complementary method to joint use in identification and validation to other secure access including use of iris, pin code or biometry.
